(19) United States
(12) Patent Application Publication
(10) Pub. No.: US 2007/0155220 A1
(43) Pub. Date: Jul. 5, 2007

(54) Electrical connector

(75) Inventors: Fu-Pin Hsieh, Tu-Cheng (TW); Fang-Jun Liao, Tu-Cheng (TW); Been-Yang Liaw, Tu-Cheng (TW); Shuo-Hsiu Hsu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/648,477

(22) Filed: Dec. 28, 2006

(30) Foreign Application Priority Data
Dec. 30, 2005 (CN) 200520140607.6

(51) Int. Cl. H01R 4/24

(52) U.S. Cl. 439/398

(57) ABSTRACT

An electrical connector in accordance with a preferred embodiment comprises an insulative housing (2), a plurality terminals (3) received in the housing (2), and the housing (2) comprises two pair of sidewalls and defines a layer of metal films (222) around outer surfaces of at least a pair of opposite sidewalls (22) thereof which can prevent disturbance of the electromagnetic waves produced by other components, hence a steady electrical connection between the electrical connector and printed circuit board can be achieved.

### BACKGROUND OF THE INVENTION

1. Field of the Invention

The present invention relates to the art of electrical connectors, and more particularly to an electrical connector provided for mechanically and electrically connecting a chip module to a printed circuit board (PCB).

2. Description of the Prior Art

Electrical connectors are widely used in the connector industry for electrically connecting a chip module to a printed circuit board (PCB) in personal computer. Conventionally, an electrical connector mainly comprises an insulative housing, a multiplicity of terminals received therein.

Referring to FIG. 1, a conventional electrical connector comprises an insulative housing 2′ a plurality of terminals 3′ received in corresponding passageways of the housing 2′, wherein the housing 2′ comprises a conducting section 21′ and four sidewalls 22′ extending from the conducting section 21′. The conducting section 21′ defines a plurality of passageways for receiving the terminals 3′. The chip module is mounted on a top surface of the housing 2′. In assembly, the chip module is connected to the circuit board by the terminals received in the electrical connector

However, the chip module or other components produces electromagnetic waves with deferent intensity, which do not screen by the conventional electrical connector described in above context. So the steady operation chip module is disturbed.

Thus, there is a need to provide a new land grid connector assembly that overcomes the above-mentioned problems.

### SUMMARY OF THE INVENTION

Accordingly, an object of the present invention is to provide an electrical connector prevent a chip module therein from electromagnetic waves disturbing coming from other components.

To fulfill the above-mentioned object, an electrical connector in accordance with a preferred embodiment comprises an insulative housing, a plurality terminals received in the housing, and the housing defines a layer of metal films around outer sidewalls thereof.

Relative to the present technology, the electrical connector in accordance with a prefer embodiment of the invention defines a layer of metal films on the outer sidewalls of the housing, which can prevent disturbance of the electromagnetic waves produced by other components, hence a steady electrical connection between the electrical connector and printed circuit board can be attained.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of a conventional electrical connector;

FIG. 2 is an exploded, isometric view of an electrical connector in accordance with a preferred embodiment of the present invention;

FIG. 3 is an assembled, isometric view of terminal of the electrical connector shown in FIG. 2;

FIG. 4 is an perspective view of the terminal received in the housing shown in FIG. 2, wherein terminals are arranged between the chip module and the printed circuit board.

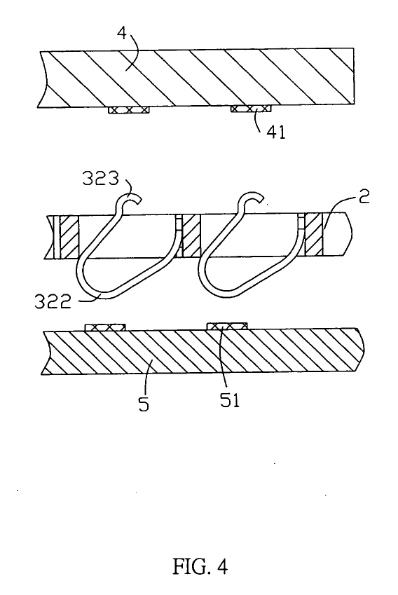

### DESCRIPTION OF PREFERRED EMBODIMENT OF THE INVENTION

Reference will now be made to the drawings to describe the present invention in detail.

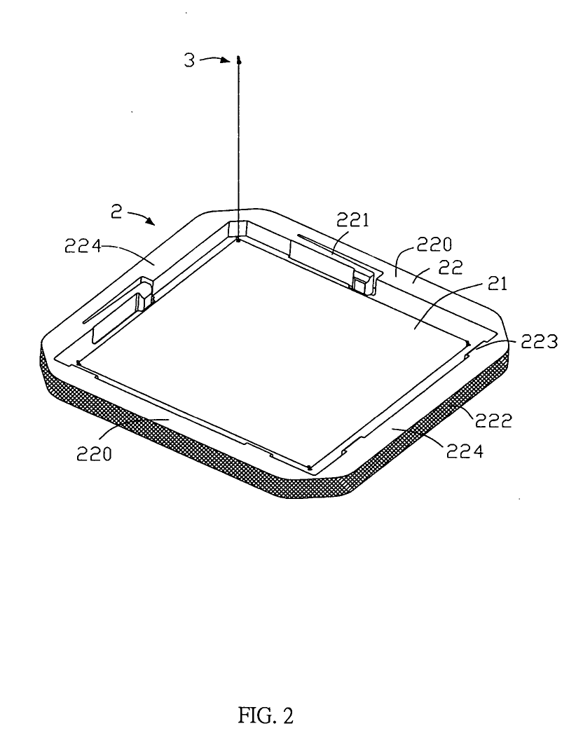

FIG. 2 is an exploded, isometric view of an electrical connector in accordance with a preferred embodiment of the present invention. The electrical connector 1 provided for electrically connecting a chip module 4 to a PCB 5 includes a generally rectangular insulative housing 2, a multiplicity of terminals 3 received in the housing 2.

The housing 2 includes a conducting section 21 and sidewalls 22 surrounding the conducting section 21. The conducting section 21 defines a plurality of passageways for receiving terminals 3 therein. The sidewalls 22 comprise a pair of first sidewall 220 opposite to each other, a pair of second sidewalls 224 connecting the first and second sidewalls 220 respectively and opposite to each other. The four sidewalls 22 cooperatively define a generally rectangular cavity in a middle section thereof for receiving the chip module 4 therein. In the four sidewalls 22, two adjacent sidewalls define a pair of elastic arms 221, the other two arms define a pair of projections 223. The elastic arms 221 and the projections 223 cooperatively secure the chip module 4 in the housing 2 and provide an elastic force, which prevent the chip module 4 from shaking in the housing 2. In addition, at least one sidewall 22 plates a layer of metal film 222 on the outer surface thereof, which is used for screen the electromagnetic waves produced from the chip module 4 and other components.

Each terminal 3 is fundamentally C-shaped and comprises a base portion 31, an elastic portion 32 extending from a center position of the base portion 31. The elastic portion 32 defines a first connecting portion 322 in a center thereof and a semicircle second connecting portion 323 in an end thereof. The first connecting portion 322 protruding outwardly from a top face of the housing 2, for resiliently electrically contacting a corresponding lead 41 of the chip module 4 and the second connecting portion 323 extends outwardly from a lower surface of the housing 2 for contacting with printed circuit board 5. The elastic portion 32 defines a recess 321 for securing the terminal 3 therein.

The base portion 31 is plate-like and comprises a securing portion 311 and a curved recess 312 formed on two outer sides thereof. The securing portion 311 is arranged on two sides of the base portion 31 and symmetry distributed relative to the elastic portion 32.

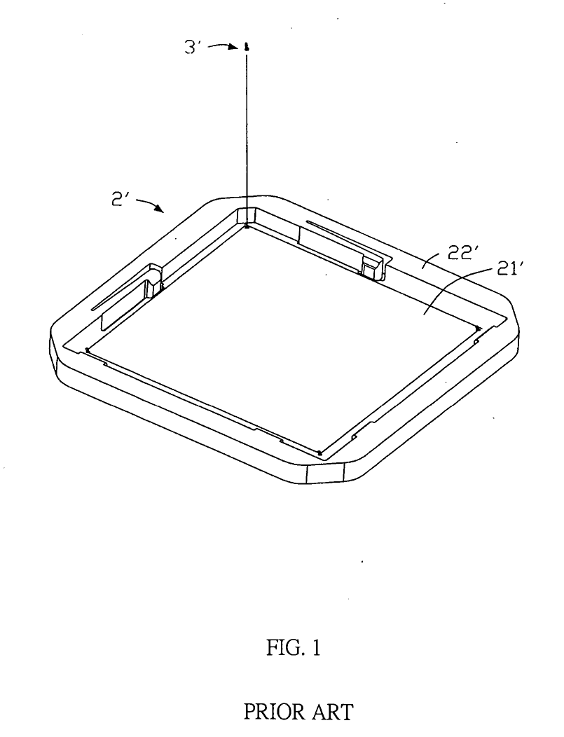

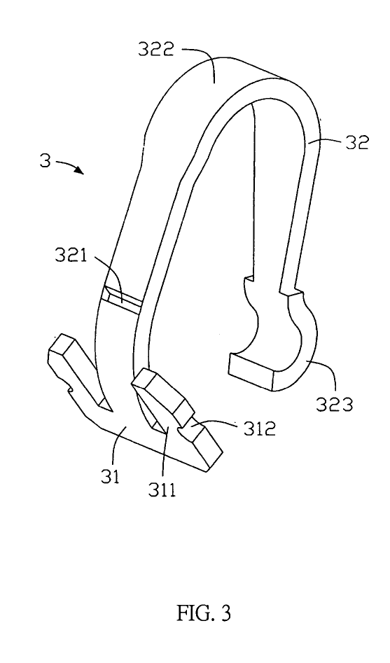

Referring to FIGS. 1-3, when the electrical connector is assembled, the terminals 3 are inserted into the passageways of the housing 2 and the chip module 4 is mounted on the housing 2. The elastic portion 221 and the projection 223 exert a pair of force perpendicular to inner surfaces of chip module 4 for securing the chip module 4 in the housing. The first connecting portion 322 and the second connecting portion 323 of the elastic portion 32 are arranged for connecting with conducting leads 41 of the chip module 4 and the printed circuit board 5 respectively, thereby the chip module 4 is electrical connected with the printed circuit board 5.

When the electrical connector connects the chip module 4 to the printed circuit board 5, the electromagnetic waves produced from the chip module 4 and other components are screened by the metal film 222 on the outer sidewalls 22 of the housing 2, which ensures a steady and reliable operation of the chip module 4. As a result, the stability and reliability of the electrical connector is attainted. It can be understood that the layer of the metal film can provide EMI protection while without the problem of the traditional metallic shield which is attached to the housing and thus may jeopardize the housing structure.

Although the present invention has been described with reference to a particular embodiment, it is not to be construed as being limited thereto. Various alterations and modifications can be made to the embodiment without in any way departing from the scope or spirit of the present invention as defined in the appended claims.

What is claimed is:

1. An electrical connector comprising:
an insulative housing comprising at least a pair of sidewalls arranged opposite sides of the housing;
a plurality of electrical terminals received in the housing;
wherein at least one sidewall of the housing defines a layer of metal film.

2. The electrical connector as claimed in claim 1, wherein at least a pair of sidewalls is two pairs and two adjacent sidewalls define a pair of elastic arms, the other two sidewalls define a pair of projections, and the elastic arms and the projections cooperatively secure the chip module in the housing.

3. The electrical connector as claimed in claim 2, wherein the terminal is C-shaped and comprises a base portion and an elastic portion.

4. The electrical connector as claimed in claim 3, wherein the elastic portion extends from a center position of the base portion and comprises a first connecting portion in a center thereof and an arched second connecting portion in an end thereof.

5. The electrical connector as claimed in claim 4, wherein the second connecting portion assumes semicircle.

6. An electrical connector comprising:
an insulative housing comprising two pairs of sidewalls arranged opposite sides of the housing, two adjacent sidewalls define a pair of elastic arms, the other two arms define a pair of projections, and the elastic arms and the projections cooperatively secure the chip module in the housing.;
a plurality of electrical terminals received in the housing comprises a base portion and an elastic portion, the elastic portion extends from a center position of the base portion and comprises a first connecting portion in a center thereof and an arched second connecting portion in an end thereof.
wherein at least one pair of sidewalls of the housing define a layer of metal film.

7. An electrical connector comprising:
an insulative housing comprising a circumferential wall;
a plurality of electrical terminals received in the housing; wherein a layer of metal film is essentially fully applied to exterior surfaces of the circumferential wall.
